(19) United States
(12) Patent Application Publication
(10) Pub. No.: US 2025/0304090 A1
(43) Pub. Date: Oct. 2, 2025

(54) SOFTWARE UPDATE MANAGEMENT DEVICE AND SOFTWARE UPDATE MANAGEMENT METHOD

(71) Applicant: HONDA MOTOR CO., LTD., Tokyo (JP)

(72) Inventors: Tomoya Kitano, Tokyo (JP); Takashi Tsujioka, Tokyo (JP)

(21) Appl. No.: 19/015,118

(22) Filed: Jan. 9, 2025

(30) Foreign Application Priority Data
Mar. 26, 2024 (JP) 2024-048978

(51) Int. Cl. B60W 50/14; B60W 40/08; G06F 8/65

(52) U.S. Cl. CPC B60W 50/14; B60W 40/08; G06F 8/65; B60W 2040/0881; B60W 2050/143; B60W 2050/146

(57) ABSTRACT

A software update management device that includes: a storage unit configured to store update recommendation information including conditions for recommending update of software of vehicle control units mounted on a vehicle, the update recommendation information being associated with the vehicle control units; and a recommendation processing unit configured to recommend update of the software based on the conditions in the update recommendation information. The conditions in the update recommendation information include a vehicle condition regarding a state of the vehicle and a situation condition indicating a situation suited for updating the software.

### INCORPORATION BY REFERENCE

The present application claims priority under 35 U.S.C.§ 119 to Japanese Patent Application No. 2024-048978 filed on Mar. 26, 2024. The content of the application is incorporated herein by reference in its entirety.

### BACKGROUND OF THE INVENTION

### Field of the Invention

The present invention relates to a software update management device and a software update management method.

### Description of the Related Art

In recent years, researches and developments on traffic safety, which are beneficial for efficient energy use, have been conducted for allowing more people to have access to reasonable, reliable, sustainable, and advanced energy. For example, Japanese Patent Laid-Open No. 2023-018282 discloses a technique with which a vehicle downloads and updates, from a server, software of an onboard control device. In the configuration disclosed in Japanese Patent Laid-Open No. 2023-018282, update processing is started when a user agrees to start update of software and, when there is no response from the user, it is determined whether to start the update processing based on the time required for the update processing.

In the meantime, various kinds of control devices are mounted on a vehicle, and the situations suited for update of software vary depending on the kinds of control devices. The problem with this is that it is difficult to make determination whether to update the software.

In order to overcome the problem, it is an object of the present application to improve the safety by performing update of software under an appropriate situation. This consequently improves the traffic safety still further and contributes to development of sustainable transportation systems.

### SUMMARY OF THE INVENTION

A first aspect of the present disclosure is a software update management device that includes: a storage unit configured to store update recommendation information including conditions for recommending update of software of vehicle control units mounted on a vehicle, the update recommendation information being associated with the vehicle control units; and a recommendation processing unit configured to recommend update of the software based on the conditions in the update recommendation information, in which the conditions in the update recommendation information include a vehicle condition regarding a state of the vehicle and a situation condition indicating a situation suited for updating the software.

Another aspect of the present disclosure is a software update management method executed by a computer that manages update of software of a vehicle, the software update management method including: storing update recommendation information including conditions for recommending update of software of vehicle control units mounted on the vehicle, the update recommendation information being associated with the vehicle control units, wherein the conditions in the update recommendation information includes a vehicle condition regarding a state of the vehicle and a situation condition indicating a situation suited for updating the software; and recommending update of the software based on the conditions in the update recommendation information.

According to one aspect of the present disclosure, update of the software of the vehicle control units is recommended to be performed under an appropriate situation based on the update recommendation information stored in association with the vehicle control units. Therefore, it is possible to improve the safety still further.

### BRIEF DESCRIPTION OF THE DRAWINGS

FIG. 1 is a diagram showing a configuration example of a software update system;

FIG. 2 is a diagram showing a configuration of a vehicle;

FIG. 3 is a schematic diagram showing examples of update recommendation information;

FIG. 4 is a flowchart showing an operation example of a management ECU; and

FIG. 5 is a flowchart showing an operation example of the management ECU.

### DETAILED DESCRIPTION OF THE INVENTION

Hereinafter, embodiments of the present invention will be described with reference to the accompanying drawings.

### 1. Configuration of Software Update System

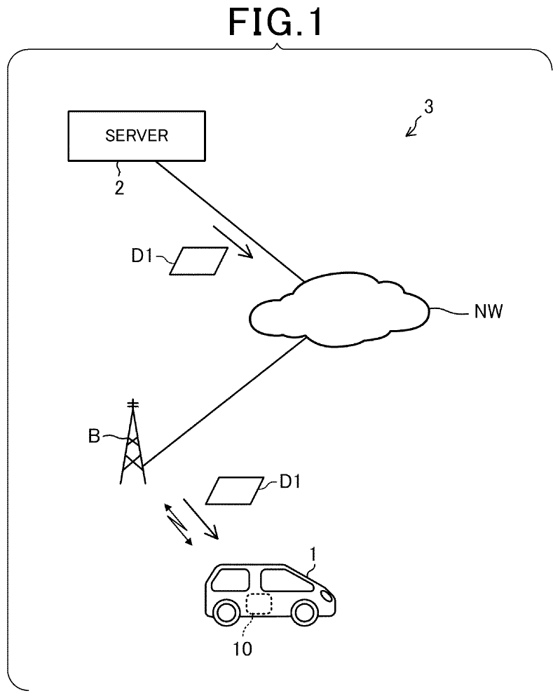

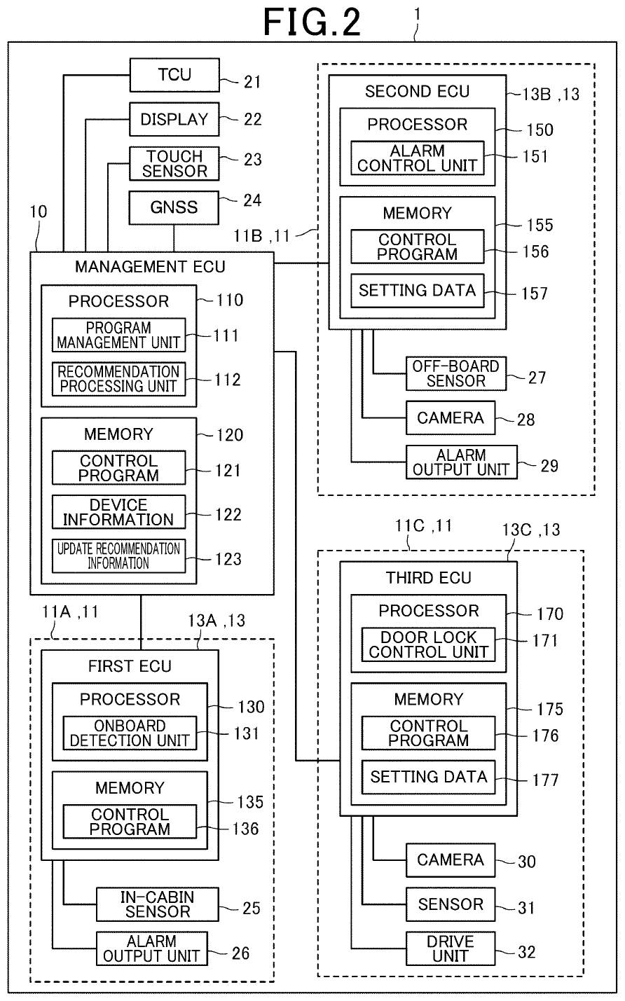

FIG. 1 is a diagram showing a configuration example of a software update system 3 related to update of software of a vehicle 1. The software update system 3 includes a server 2 that provides software to be executed by vehicle control units 13 (FIG. 2) mounted on the vehicle 1, and the server 2 is connected to the vehicle 1 to be communicable via a communication network NW. The vehicle 1 downloads software from the server 2, and updates the software included in the vehicle control units 13. In other words, the software update system 3 enables update of the software in the vehicle 1 by OTA (On The Air).

Note here that update of software means processing for replacing the software executed by the processor with the latest version of software, and specific forms thereof may be any of adding, deleting, and overwriting software. Furthermore, processing for deleting part of or entire software executed by the processor, installing new software, and deleting, adding, and overwriting data used when executing the software may also be included in update of software. In the following description, software includes a program executed by a processor as well as data that is referred to, generated, updated, and deleted in association with the program, and includes firmware.

The server 2 is connected to the communication network NW via a wired communication line or a wireless communication line. The vehicle 1 is connected to the communication network NW by wireless communication via a cellular communication base station B, for example. There is no limit set for the specific form of the communication network NW. For example, the communication network NW may include a cellular communication network, the Internet, WAN (Wide Area Network), LAN (Local Area Network), a public network, a provider device, a dedicated line, a base station, and the like.

### 2. Configuration of Vehicle

FIG. 2 is a diagram showing a configuration of the vehicle 1.

The vehicle 1 may be a four-wheel vehicle, a two-wheel vehicle, and any other vehicle, and may also be a large vehicle, a commercial vehicle, a work vehicle, or the like. As an example, it is assumed to be a four-wheel vehicle in the present embodiment. Furthermore, the vehicle 1 may be any of an electric vehicle that includes a motor running on electric power as the driving source and a vehicle having an internal combustion engine mounted thereon. The internal combustion engine may function as a power source for driving the vehicle 1, and may also be a power generation device that drives a generator.

The vehicle 1 includes a plurality of devices 11 that implement the functions of the vehicle 1, and each of the devices 11 includes the vehicle control unit 13 that controls the respective device 11. The vehicle control unit 13 is an ECU (Electronic Control Unit), for example, and controls the device 11 by executing a program.

In the present embodiment, transition of the operation state of the vehicle 1 is made among three kinds of states including an ignition-on state, an ignition-off state, and a stopped state. The ignition-on state is a state where a motor and an internal congestion engine as the driving source of the vehicle 1 is running. The state where the motor is running is not limited to a state where the motor is rotating. It also includes a state where the electric power can be supplied to the motor from an inverter circuit or the like, which includes a state where the motor can be promptly rotated in response to an operation of the driver such as an operation of the accelerator pedal, and the like. For example, the ignition-on state can also be expressed as a state where the inverter circuit is working. In the ignition-on state, a state where the motor is not rotating may also be referred to as an ignition-ready (IG_Ready). This state is also included in the ignition-on. When the vehicle 1 has the internal combustion engine mounted thereon, the ignition-on state includes a state where the internal combustion engine is rotating and a state where the internal combustion engine can be promptly started. The ignition-off state is a state where the motor and the internal congestion engine as the driving source are not operating, electric power is supplied at least to some of the control devices of the vehicle 1 including the vehicle control units 13, and those control devices are operable. The stopped state is a state where electric power is supplied to the minimum control devices required for placing the vehicle 1 to the ignition-off state, and supply of electric power is stopped for the other control devices and the driving source of the vehicle 1. For example, an alarm device 11B and a door lock device 11C to be described in the followings operate also in the stopped state, and an onboard detection device 11A stops in the stopped state of the vehicle 1.

As examples of the devices 11 provided in the vehicle 1, FIG. 2 illustrates the onboard detection device 11A, the alarm device 11B, and the door lock device 11C, which are referred to as the devices 11 when there is no need to distinguish.

The onboard detection device 11A is a device that detects presence of a person inside a vehicle cabin where the driver, and passengers other than the driver of the vehicle 1 get in.

The onboard detection device 11A includes a first ECU 13A, and an in-cabin sensor 25 and an alarm output unit 26 are connected to the first ECU 13A. The first ECU 13A is an example of the vehicle control unit 13. The in-cabin sensor 25 is a sensor that detects presence of a person inside the vehicle cabin. The in-cabin sensor 25 is, for example, an ultrasonic sensor or a radar sensor that detects presence of an object and/or motion of the object inside the vehicle cabin, a weight sensor that detects a load applied to seats of the vehicle 1, an infrared sensor that detects a person or an animal inside the vehicle cabin, or other sensors. The alarm output unit 26 is a device that issues an alarm under the control of the first ECU 13A. The alarm output unit 26 is a display that displays a notification, a LED (Light Emitting Diode) indicator that illuminates at the time of notification, other indicator lamps, a speaker that outputs a notification sound, and the like. The alarm output unit 26 is a communication device that has a communication function, and may output an alarm by transmitting a signal, data, audio, or the like to a predetermined point of contact under the control of the first ECU 13A. The first ECU 13A is an example of a first vehicle control unit.

The first ECU 13A includes a processor 130 and a memory 135. The memory 135 is a nonvolatile storage device constituted of a magnetic recording medium or a semiconductor memory element, and stores a control program 136 that is executed by the processor 130 and data that is referred to, generated, or processed when executing the control program 136.

The processor 130 functions as an onboard detection unit 131 by executing the control program 136. The onboard detection unit 131 starts a detection operation using the in-cabin sensor 25, having the fact that the vehicle 1 is shifted from the ignition-on state to the ignition-off state as the trigger. When detected that there is a person inside the vehicle cabin of the vehicle 1 during the execution of the detection operation, the onboard detection unit 131 issues a notification by the alarm output unit 26. The onboard detection device 11A is used, for example, to prevent such circumstances that children or pets are left inside the vehicle cabin of the vehicle 1.

The alarm device 11B is a device that detects vibration of the vehicle 1, suspicious approach and contact toward the vehicle 1, or other type of access made by a person to the vehicle 1 when the vehicle 1 is being stopped or parked, and outputs an alarm. The alarm device 11B operates in the stopped state of the vehicle 1.

The alarm device 11B includes a second ECU 13B, and an off-board sensor 27, a camera 28, and an alarm output unit 29 are connected to the second ECU 13B. The second ECU 13B is an example of the vehicle control unit 13. The off-board sensor 27 may be a sensor that detects a person or an object approaching the surroundings of the vehicle 1 outside the vehicle 1. The off-board sensor 27 may also be a sensor that detects contact to the vehicle 1. The off-board sensor 27 is, for example, an ultrasonic sensor, a vibration sensor, a radar sensor, or the like. The camera 28 is a digital camera that captures images of the surroundings of the vehicle 1 outside the vehicle 1, and captures video or still images. The alarm output unit 29 is a device that outputs an alarm under the control of the second ECU 13B. The alarm output unit 29 is a display that displays a notification, a LED indicator that illuminates at the time of notification, other indicator lamps, a speaker that outputs a notification sound, and the like. The alarm output unit 29 may be a device used in common with the alarm output unit 26 or may be a device different from the alarm output unit 26. The alarm output unit 29 is a communication device that has a communication function, and may output an alarm by transmitting a signal, data, audio, or the like to a predetermined point of contact under the control of the second ECU 13B. The second ECU 13B is an example of a second vehicle control unit.

The second ECU 13B includes a processor 150 and a memory 155. The memory 155 is a nonvolatile storage device constituted of a magnetic recording medium or a semiconductor memory element, and stores a control program 156 that is executed by the processor 150 and data that is referred to, generated, or processed when executing the control program 156. For example, the memory 155 stores setting data 157.

The processor 150 functions as an alarm control unit 151 by executing the control program 156. The alarm control unit 151 starts a detection operation using at least one of the off-board sensor 27 and the camera 28, having the fact that the vehicle 1 is shifted to the stopped state as the trigger. During the execution of the detection operation, the alarm control unit 151 analyzes the detection result of the off-board sensor 27 and captured images captured by the camera 28. The alarm control unit 151 collates the analysis result with the setting data 157 to detect suspicious behaviors toward the vehicle 1, vibration of the vehicle 1, and the like. When a suspicious behavior toward the vehicle 1 or vibration of the vehicle 1 is detected, the alarm control unit 151 issues a notification by the alarm output unit 29 and saves the captured images of the camera 28 in the memory 155. The alarm device 11B is used to prevent damages to the vehicle 1 and theft of the vehicle 1 while the vehicle 1 is being stopped or parked, for example.

The door lock device 11C is a device that controls locking and unlocking opening/closing parts included in the vehicle 1. The opening/closing parts include doors that are provided at the sides of the body of the vehicle 1 and opened/closed when passengers get in and off, a rear hatch door, a trunk lid, and the like provided on the rear side of the car body. The door lock device 11C has, in each of the opening/closing parts, a lock mechanism, not shown, which locks the opening/closing part so that it does not open, and controls a lock drive unit 32 for moving the lock mechanism by a third ECU 13C. The lock drive unit 32 is a power device that locks and unlocks the lock mechanism, and it is an actuator or a motor, for example. The door lock device 11C operates in the ignition-on state, the ignition-off state, and the stopped state of the vehicle 1. The third ECU 13C is an example of a third vehicle control unit.

A camera 30 and a sensor 31 are connected to the third ECU 13C. The camera 30 is a digital camera that captures images of the surroundings of the vehicle 1 outside the vehicle 1, and captures video or still images. The camera 30 may be a device used in common with the camera 28, or may be provided separately from the camera 28. The sensor 31 is a device that detects operations performed by the passengers for the vehicle 1. The sensor 31 includes a touch sensor that detects contact operations to the doorknobs of the vehicle 1, for example. Furthermore, the sensor 31 may include a wireless communication device that performs wireless communication with an FOB key and a smartphone held by the passenger. The sensor 31 may also include a switch for detecting that a key (physical key) held by the passenger is inserted into a keyhole provided in the opening/closing part of the vehicle 1 and that the key is turned to physically lock or unlock.

The third ECU 13C includes a processor 170 and a memory 175. The memory 175 is a nonvolatile storage device constituted of a magnetic recording medium or a semiconductor memory element, and stores a control program 176 that is executed by the processor 170 and data that is referred to, generated, or processed when executing the control program 176. For example, the memory 175 stores setting data 177.

The processor 170 functions as a door lock control unit 171 by executing the control program 176. The door lock control unit 171 executes an image entry function of the vehicle 1 as well as locking and unlocking of the vehicle 1 using an FOB key or a physical key. Upon detecting that a person registered in advance as a user of the vehicle 1 is about to get in the vehicle 1 by importing the captured images of the camera 30 and making analysis by comparing those with the setting data 177, the door lock control unit 171 operates the lock drive unit 32 to unlock the opening/closing part of the vehicle 1. Furthermore, when an unlocking operation by the passenger of the vehicle 1 is detected by the sensor 31, the door lock control unit 171 unlocks the opening/closing part of the vehicle 1 by operating the lock drive unit 32. Also, when a locking operation by the passenger of the vehicle 1 is detected by the sensor 31, the door lock control unit 171 locks the opening/closing part of the vehicle 1 by operating the lock drive unit 32.

The vehicle 1 includes a management ECU 10. The management ECU 10 manages update of the software of the vehicle control units 13 provided in the vehicle 1. In the example illustrated in FIG. 2, the management ECU 10 has the first ECU 13A, the second ECU 13B, and the third ECU 13C as the target, and manages update of the program executed by those ECUs and the data that is processed during execution of the program. The management ECU 10 is an example of the software update management device.

A TCU (Telematics Control Unit) 21, a display 22, a touch sensor 23, and a GNSS (Global Navigation Satellite System) 24 are connected to the management ECU 10. The TCU 21 is a communication device that complies with the communication standard of a mobile communication system, and communicates with devices other than the vehicle 1. The TCU 21 includes an antenna, a transmitter, and a receiver, for example, and performs communication under the control of the management ECU 10.

The display 22 includes a liquid crystal display panel or an organic EL (Electro Luminescence) panel, and displays characters and images. The display 22 is installed on a dashboard of the vehicle 1, for example. The touch sensor 23 is placed by being superimposed on a display screen of the display 22, and detects touch operations of the passengers in the vehicle 1. The GNSS 24 measures a location of the vehicle 1 by receiving wireless signals transmitted from a satellite.

The management ECU 10 includes a processor 110 and a memory 120. The memory 120 is a nonvolatile storage device constituted of a magnetic recording medium or a semiconductor memory element, and stores a control program 121 that is executed by the processor 110. Furthermore, the memory 120 stores device information 122 and update recommendation information 123. The device information 122 includes information regarding the devices 11 provided in the vehicle 1 and the vehicle control units 13 that control the devices 11. The device information 122 includes, for each of the devices 11, for example, version, last updated data, size, and the like of the programs executed by the vehicle control units 13 and data used by the vehicle control units 13. The update recommendation information 123 will be described later. The memory 120 corresponds to an example of a storage unit.

The processor 110 functions as a program management unit 111 and a recommendation processing unit 112 by executing the control program 121.

The program management unit 111 manages update of the programs executed by the vehicle control units 13 and the data to be processed by the vehicle control units 13.

Specifically, the program management unit 111 detects the version of the control program 136 and, when a new version of the control program 136 can be supplied from the server 2, executes update of the control program 136. In this case, the program management unit 111 downloads update data D1 for updating the control program 136 from the server 2. The program management unit 111 updates the control program 136 by using the downloaded update data D1 according to an operation of the passenger of the vehicle 1.

Furthermore, the program management unit 111 detects the versions of the control program 156 and the setting data 157 and, when new versions of the control program 156 and/or the setting data 157 can be supplied from the server 2, executes update of the control program 156 and/or the setting data 157. In this case, the program management unit 111 downloads the update data D1 for updating the control program 156 and/or the setting data 157 from the server 2. The program management unit 111 updates the control program 156 and/or the setting data 157 by using the downloaded update data D1 according to an operation of the passenger of the vehicle 1. The program management unit 111 performs the same processing for the control program 176 and the setting data 177.

The recommendation processing unit 112 recommends update of the software to the passenger of the vehicle 1, when the program management unit 111 can execute update of the software of the vehicle control unit 13. The recommendation processing unit 112 displays, on the display 22, a message for recommending update of the software and a message for requesting input regarding whether to approve update of the software, for example. Note here that the recommendation processing unit 112 may display information regarding the vehicle control unit 13 to be the target of software update on the display 22, or may display the information regarding the device 11 that is controlled by the vehicle control unit 13 on the display 22.

The recommendation processing unit 112 receives an operation of the passenger of the vehicle 1 made on the touch sensor 23 in response to the massages displayed on the display 22. When an operation for approving update of the software is made by the passenger of the vehicle 1, the recommendation processing unit 112 causes the program management unit 111 to execute update of the software. Also, when an operation for disapproving update of the software (disapproval operation) is made by the passenger of the vehicle 1, the recommendation processing unit 112 suspends the action for recommending update of the software for a prescribed period of time.

The recommendation processing unit 112 recommends the passenger of the vehicle 1 to execute update of the software of the vehicle control unit 13 under a situation that matches the condition in the update recommendation information 123.

The update recommendation information 123 is information that includes the conditions for recommending update of the software of the vehicle control units 13, and stored in the memory 120 while being associated with the vehicle control units 13.

### 3. Update Recommendation Information

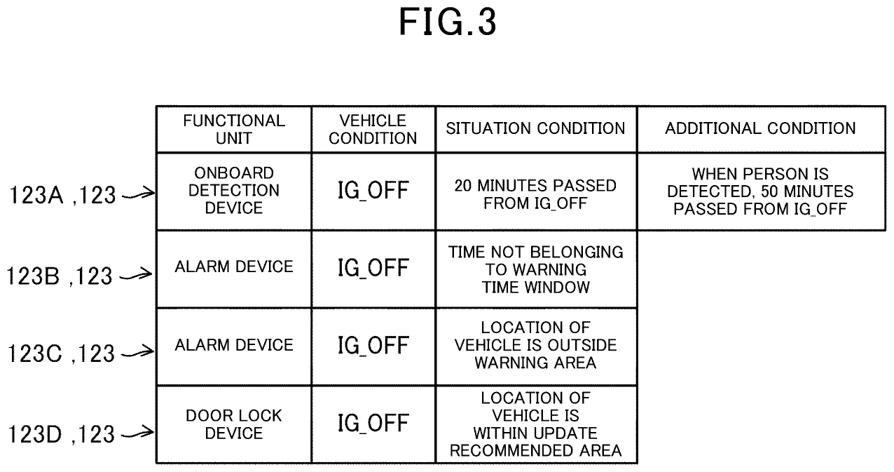

FIG. 3 is a schematic diagram showing examples of the update recommendation information 123.

The update recommendation information 123 includes the conditions regarding the states or situations suited for updating the software. The recommendation processing unit 112 recommends update of the software based on the conditions included in the update recommendation information 123. Then, when the passenger of the vehicle 1 approves update of the software, the recommendation processing unit 112 causes the program management unit 111 to execute update of the software when the recommended condition is satisfied.

For example, as shown in FIG. 3, the update recommendation information 123 includes vehicle condition, situation condition, and additional condition. The vehicle condition is the condition regarding the states of the vehicle 1. Specifically, the states of the vehicle 1 are the ignition-on state (IG_ON), the ignition-off state (IG_OFF), and the stopped state of the vehicle 1.

The situation condition in the update recommendation information 123 is the condition regarding the situations of the vehicle 1. The situations of the vehicle 1 are the time and the location of the vehicle 1 when updating the software. The additional condition is the supplementary condition added to the situation condition. For example, the additional condition is, under the situation that satisfies the situation condition, a condition applied when an event that affects whether it is suited for updating the software occurs.

The update recommendation information 123 is stored in the memory 120 by being associated with the vehicle control units 13 to be the target of software update. The update recommendation information 123 includes the conditions corresponding to the devices 11 that are controlled by the vehicle control units 13. Thus, it is also possible to say that the update recommendation information 123 is stored in the memory 120 by being associated with the devices 11.

As examples of the update recommendation information 123, FIG. 3 shows update recommendation information 123A, 123B, 123C, and 123D. The update recommendation information 123A is an example of first update recommendation information, the update recommendation information 123B and the update recommendation information 123C are examples of second update recommendation information, and the update recommendation information 123D is an example of third update recommendation information.

The update recommendation information 123A is associated with the first ECU 13A that controls the onboard detection device 11A. The update recommendation information 123A includes, as the vehicle condition, the vehicle 1 being in the ignition-on state. The update recommendation information 123A includes, as the situation condition, 20 minutes passing after the vehicle 1 enters the ignition-off state. Note that the time “20 minutes” included in the update recommendation information 123A is the time for which the onboard detection device 11A performs a detection operation. That is, the update recommendation information 123A is the information that recommends update of the software of the first ECU 13A after the detection operation of the onboard detection device 11A is finished.

The update recommendation information 123A includes the additional condition. The additional condition in the update recommendation information 123A is the condition applied when the onboard detection device 11A detects a person, which includes the fact that 50 minutes has passed from the ignition-off. Upon detecting a person inside the vehicle cabin, the onboard detection device 11A issues a notification and, after the detection, executes a detection operation for additional 30 minutes. Note that the time “50 minutes” included in the additional condition in the update recommendation information 123A is the longest time for which the detection operation is performed after the person is detected by the onboard detection device 11A. That is, the additional condition in the update recommendation information 123A is the condition for recommending update of the software of the first ECU 13A after the detection operation is finished, when a person is detected by the onboard detection device 11A.

In general, it is recommended that the vehicle 1 is in the ignition-off or the stopped state while updating the software related to the devices 11 of the vehicle 1. Furthermore, the onboard detection device 11A cannot be operated while updating the software of the first ECU 13A. Therefore, it is desirable to update the software related to the onboard detection device 11A under a situation where the vehicle 1 is not in the ignition-on and there is no problem even when the onboard detection device 11A is not operating. In order to implement such software update, the update recommendation information 123A includes, as a condition, being under the situation where the vehicle 1 is not in the ignition-on and there is no problem even when the onboard detection device 11A is not operating.

The update recommendation information 123B and the update recommendation information 123C are associated with the second ECU 13B that controls the alarm device 11B. The update recommendation information 123B and the update recommendation information 123C include, as the vehicle condition, the vehicle 1 being in the ignition-off state.

The update recommendation information 123B includes, as the situation condition, being the time not belonging to a warning time window determined in advance. The update recommendation information 123C includes, as the situation condition, the location of the vehicle 1 being outside a warning area. The warning time window is a time window where it has high risk of having vandalism to the vehicle 1 and theft of the vehicle 1. The warning area indicates the area where it has high risk of having vandalism to the vehicle 1 and theft of the vehicle 1. The warning time window and the warning area are defined based on, for example, criminal statistics and the like of the area the vehicle 1 is mainly used.

While updating the software related to the alarm device 11B, the alarm device 11B cannot stay vigilant. Thus, the update recommendation information 123B and the update recommendation information 123C recommend, as the situation to execute update of the software, a situation where there is only little concern about the alarm device 11B not being vigilant. The update recommendation information 123B and the update recommendation information 123C are both associated with the alarm device 11B, and correspond to the second ECU 13B. The recommendation processing unit 112 may recommend update of the software of the second ECU 13B based on either the update recommendation information 123B or the update recommendation information 123C. Furthermore, the recommendation processing unit 112 may recommend update of the software based on both of the update recommendation information 123B and the update recommendation information 123C. For example, the update recommendation unit 12 may recommend update of the software when it matches the vehicle conditions and the situation conditions in both of the update recommendation information 123B and the update recommendation information 123C.

The update recommendation information 123D is associated with the third ECU 13C that controls the door lock device 11C. The update recommendation information 123D includes, as the vehicle condition, the vehicle 1 being in the ignition-on state. The update recommendation information 123D includes, as the situation condition, the location of the vehicle 1 being within an update recommended area. The update recommended area is the area where it is less likely to have disadvantages caused due to the fact that the door lock device 11C is not operating during the update processing of the software. For example, if the update processing of the software of the third ECU 13C is executed when the driver of the vehicle 1 goes shopping and parks the vehicle 1, the driver cannot get in the vehicle 1 until the update processing is completed. In the meantime, when the update processing of the software of the third ECU 13C is executed while the vehicle 1 is parked in the parking space in the driver's home, the fact that the driver cannot get in the vehicle 1 does not cause much trouble. The update recommendation information 123D includes the condition for executing update of the software of the third ECU 13C under the situation where the fact that the driver cannot get in the vehicle 1 is not likely to cause trouble.

It is desirable for the update recommended area in the update recommendation information 123D to be determined based on the use condition and use place of the vehicle 1. Therefore, as will be described later, the recommendation processing unit 112 can generate the update recommendation information 123D based on the use record of the vehicle 1.

Furthermore, although not shown, the update recommendation information 123D may include a condition that designates the time window where it is less likely to have disadvantages caused due to the fact that the door lock device 11C is not operating during the update processing of software. In this case, the recommendation processing unit 112 recommends the situation where both of the time window and the location of the vehicle 1 satisfy the update recommendation information 123D.

The update recommendation information 123 may be stored in advance in the management ECU 10, or the management ECU 10 may acquire the update recommendation information 123 from the server 2 and store it in the memory 120. Furthermore, the management ECU 10 may generate and edit the update recommendation information 123 based on input made on the touch sensor 23. The management ECU 10 may also generate and edit the update recommendation information 123 based on information acquired from the server 2. For example, the management ECU 10 may acquire the information regarding the warning time window and the warning area from the server 2, and edit or update the update recommendation information 123B and the update recommendation information 123C based on the acquired information.

### 4. Operations of Management ECU

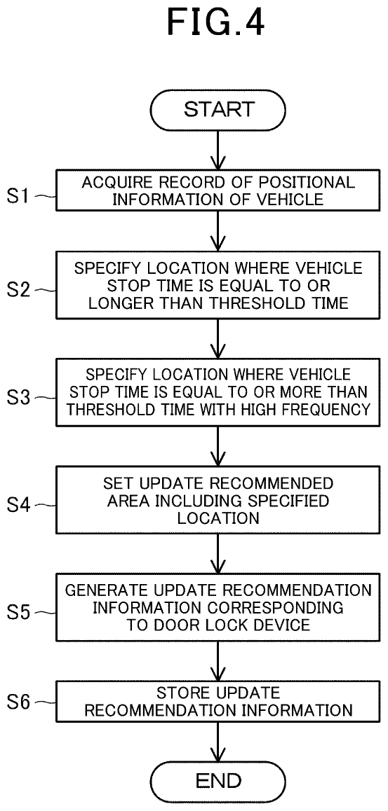

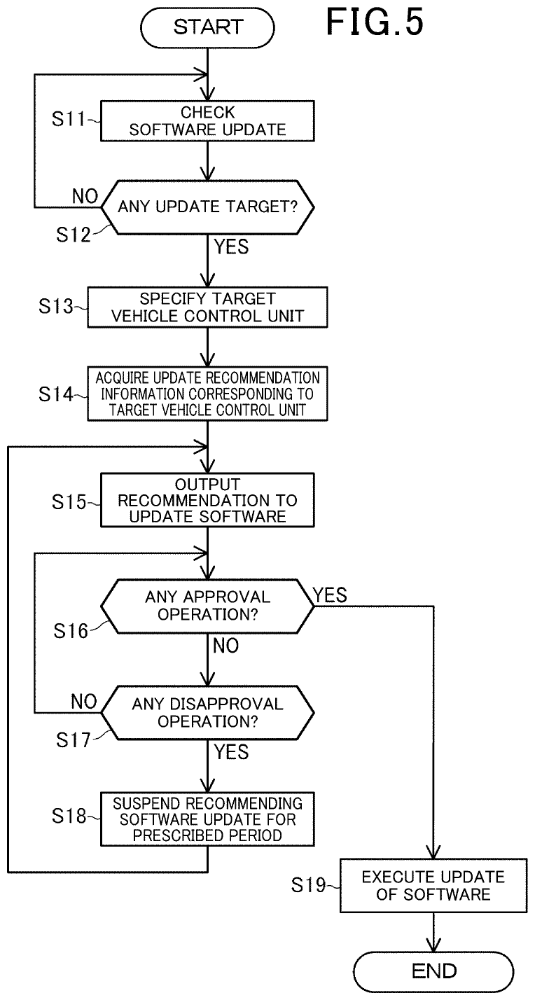

FIG. 4 and FIG. 5 are flowcharts showing operation examples of the management ECU 10. The operation indicated in FIG. 5 corresponds to an example of a software update management method. Steps S1 to S6 indicated in FIG. 4 are executed by the recommendation processing unit 112. Furthermore, steps S11 to S13 and step S19 indicated in FIG. 5 are executed by the program management unit 111, and steps S14 to S18 are executed by the recommendation processing unit 112.

FIG. 4 shows the operation for generating the update recommendation information 123 based on the use record of the vehicle 1. For example, the update recommendation information 123D is generated through the operation shown in FIG. 4.

The management ECU 10 acquires the record of positional information of the vehicle 1 (step S1). The record of the positional information of the vehicle 1 may be recorded by the management ECU 10. The management ECU 10 may store the record of the positions measured by the GNSS 24 in the memory 120, and create a record. Furthermore, the management ECU 10 may acquire the record of the positional information of the vehicle 1 from the server 2.

The management ECU 10 specifies, from the record of the positional information acquired in step S1, the position where the stop time of the vehicle 1 is equal to or more than a threshold time (step S2). Note here that the stop time of the vehicle 1 indicates the time for which the vehicle 1 stays at a same place, regardless of whether the vehicle 1 is in the stopped state or the ignition-off state. For example, it does not matter whether the vehicle 1 is being parked or stopped.

The management ECU 10 specifies, from the locations specified in step S2, the location where the stop time of the vehicle 1 equals to or more than the threshold with high frequency (step S3). The management ECU 10 sets the update recommended area including the location specified in step S3 (step S4), and generates the update recommendation information 123D that includes the set update recommended area and corresponds to the door lock device 11C (step S5). The management ECU 10 stores the generated update recommendation information 123D in the memory 120 in association with the door lock device 11C (step S6), and ends the present processing.

FIG. 5 shows an example of the operation of the management ECU 10 for updating the software of the vehicle control unit 13.

The management ECU 10 communicates with the server 2 to check software update (step S11). In step S11, the management ECU 10 checks whether the vehicle control units 13 provided in the vehicle 1 are the target of software update based specifically on the device information 122.

The management ECU 10 determines whether there is any vehicle control unit 13 to be the target of software update (step S12). When there is no vehicle control unit 13 to be the target of software update (NO in step S12), the management ECU 10 returns to step S11, and executes step S11 in a predetermined period.

When there is the vehicle control unit 13 to be the target of software update (YES in step S12), the management ECU 10 specifies the vehicle control unit 13 to be the target (step S13). The management ECU 10 acquires, from the memory 120, the update recommendation information 123 that is stored by being associated with the specified vehicle control unit 13 (step S14).

The management ECU 10 outputs recommendation to encourage update of the software based on the update recommendation information 123 acquired in step S14 (step S15). In step S15, the management ECU 10 displays, on the display 22, a message for recommending update of the software and a message for requesting input regarding whether to approve update of the software, for example. The management ECU 10 may display, on the display 22, the information regarding the vehicle control unit 13 to be the target of software update and the information regarding the device 11 that is controlled by the vehicle control unit 13. Furthermore, when the vehicle 1 has a speaker, the management ECU 10 may recommend update of the software by voice in step S15.

The management ECU 10 determines whether an operation for giving approval to update of the software is made on the touch sensor 23 by the passenger of the vehicle 1 in responds to the messages displayed on the display 22 (step S16). When no operation for giving approval to update of the software is made (NO in step S16), the management ECU 10 determines whether an operation for not approving update of the software (disapproval operation) is made by the passenger of the vehicle 1 (step S17). When the disapproval operation is not made (NO in step S17), the management ECU 10 returns to step S16. When the disapproval operation is made (YES in step S17), the management ECU 10 suspends the action for recommending update of the software for a prescribed period of time (step S18), and returns to step S15 and outputs recommendation after the prescribed period of time.

Furthermore, when the operation for giving approval to update of the software is made (YES in step S16), the management ECU 10 executes update of the software (step S19) when the condition indicated in the update recommendation information 123 acquired in step S14 is satisfied thereafter. The management ECU 10 may download the update data D1 from the server 2 before step S19. For example, the management ECU 10 may download the update data D1 from the server 2 during the operation of steps S13 to S18.

Furthermore, when there are a plurality of vehicle control units 13 specified to be the target of software update in step S13, the management ECU 10 may collectively recommend update of the software for the plurality of vehicle control units 13 in step S15. Furthermore, the operation of steps S14 to S18 may be executed for each of the plurality of vehicle control units 13.

### 5. Other Embodiments

Note that the embodiment described above is only one mode of the present invention, and any modifications and applications thereof are possible without departing from the scope of the present invention.

The configuration of the vehicle 1 shown in FIG. 2 is an example only, and the vehicle 1 may also be in a configuration not shown in FIG. 2. For example, as the devices 11, the vehicle 1 may include ICB (Infotainment Control Box), MPU (Map Positioning Unit), MVC (Multi View Camera), PKS (Parking Support System), and ADAS (Advanced Driver Assistance System). The vehicle 1 may also include a travel motor for allowing the vehicle 1 to travel, operation devices such as an accelerator pedal and a brake pedal, a VSA (Vehicle Stability Assist) device, a drive battery for driving the motor, and the like. The vehicle 1 may include the vehicle control units 13 for controlling each of the devices 11. Furthermore, it is also possible to apply the present disclosure to the vehicle 1 that does not include some of the devices 11 shown in FIG. 2.

While the configuration in which the management ECU 10 that includes the program management unit 111 and the recommendation processing unit 112 is provided separately from the vehicle control units 13 that controls the devices 11 is described in the embodiment above, it is only an example. Specific arrangement of the functional units corresponding to the management ECU 10 can be changed as appropriate. For example, any of the vehicle control units 13 provided in the vehicle 1 may have the functions of the program management unit 111 and the recommendation processing unit 112 of the management ECU 10. Furthermore, the management ECU 10 may be a configuration that has the same functions as those of the vehicle control units 13.

Note that FIG. 2 is a schematic diagram which, in order to facilitate the understanding of the invention of the present application, shows the configuration of the vehicle 1 in blocks. However, the subjects to which the present disclosure is applied are not limited to the configuration illustrated therein. Furthermore, the processing of each of the structural elements may be executed by a single hardware unit or may be executed by a plurality of hardware units. Moreover, the processing shown in FIG. 4 and FIG. 5 may be executed by a single program or may be executed by a plurality of programs.

### 6. Configuration Supported by the Embodiments

The above-described embodiments support the following configurations.

(Configuration 1) A software update management device including: a storage unit configured to store update recommendation information including conditions for recommending update of software of vehicle control units mounted on a vehicle, the update recommendation information being associated with the vehicle control units; and a recommendation processing unit configured to recommend update of the software based on the conditions in the update recommendation information, in which the conditions in the update recommendation information include a vehicle condition regarding a state of the vehicle and a situation condition indicating a situation suited for updating the software.

According to the software update management device of configuration 1, it is possible to recommend update of the software of the vehicle control units to be performed under an appropriate situation by the use of the update recommendation information that defines the conditions regarding update of the software in association with the vehicle control units. This makes it possible to avoid the software from being updated under a situation that may cause trouble due to the fact that the vehicle control units cannot be used temporarily. As a result, it is possible to prevent inconveniences caused due to update of the software, and to improve the safety still further.

(Configuration 2) The software update management device according to configuration 1, in which the vehicle condition includes the vehicle entering an ignition-off state, and the situation condition includes the situation of the vehicle being suited for updating the software.

According to the software update management device of configuration 2, it is possible to recommend update of the software to be performed in a state where the vehicle is placed in the ignition-off state and the situation of the vehicle is appropriate. This makes it possible to more securely prevent inconveniences caused due to update of the software, and to improve the safety still further.

(Configuration 3) The software update management device according to configuration 1 or 2, in which the vehicle control units include a first vehicle control unit configured to control a functional unit that is configured to operate until a first prescribed period of time elapses after the vehicle enters an ignition-off state, the update recommendation information stored in the storage unit includes first update recommendation information that is associated with the first vehicle control unit, and the first update recommendation information includes, as the situation condition, the first prescribed period of time elapsing after the vehicle enters the ignition-off state.

According to the software update management device of configuration 3, it is possible to recommend update of the software of the first vehicle control unit to be performed by avoiding the operation time of the device controlled by the first vehicle control unit. Therefore, in regard to the device operating in a specific operation time, it is possible to prevent inconveniences caused due to update of the software, and to improve the safety still further.

(Configuration 4) The software update management device according to configuration 3, in which the functional unit is an onboard detection device configured to detect presence of a person inside the vehicle.

According to the software update management device of configuration 4, it is possible to recommend update of the software to be performed without causing trouble for the use of the onboard detection device.

(Configuration 5) The software update management device according to configuration 4, in which the first update recommendation information includes, as the situation information, an additional condition applied when the onboard detection device detects a person, and the additional condition includes a second prescribed period of time longer than the first prescribed period of time elapsing after the vehicle enters the ignition-off state.

According to the software update management device of configuration 5, even in a case where a person is detected by the onboard detection device, it is possible to recommend update of the software to be performed without causing trouble for the use of the onboard detection device thereafter.

(Configuration 6) The software update management device according to any one of configurations 1 to 5, in which the vehicle control units include a second vehicle control unit configured to control an alarm device that is configured to execute an alarm function while the vehicle is being stopped, the update recommendation information stored in the storage unit includes second update recommendation information that is associated with the second vehicle control unit, and the second update recommendation information includes, as the situation condition, at least one selected from a condition that a location of the vehicle is not in a high-risk area for theft and a condition that time at which the vehicle enters an ignition-off state is not included in a high-risk time window for theft.

According to the software update management device of configuration 6, it is possible to recommend update of the software related to the alarm device of the vehicle to be performed under a situation where it is not likely to cause any concern due to the fact that the alarm device stops for updating the software. This makes it possible to prevent inconveniences caused due to update of the software related to the alarm device, and to improve the safety still further.

(Configuration 7) The software update management device according to any one of configurations 1 to 6, in which the vehicle control units include a third vehicle control unit configured to control a lock device that is configured to lock and unlock the vehicle, the update recommendation information stored in the storage unit includes third update recommendation information that is associated with the third vehicle control unit, and the third update recommendation information includes, as the situation condition, being in a situation assumed to be suited for updating the software from a use record of the vehicle.

According to the software update management device of configuration 7, it is possible to recommend update of the software related to the lock device to be performed under a situation where it is not likely to cause any concern due to the fact that the lock device stops for updating the software. This makes it possible to prevent inconveniences caused due to update of the software related to locking and unlocking of the vehicle, and to improve the safety still further.

(Configuration 8) A software update management method executed by a computer that manages update of software of a vehicle, the software update management method including: storing update recommendation information including conditions for recommending update of software of vehicle control units mounted on the vehicle, the update recommendation information being associated with the vehicle control units, wherein the conditions in the update recommendation information includes a vehicle condition regarding a state of the vehicle and a situation condition indicating a situation suited for updating the software; and recommending update of the software based on the conditions in the update recommendation information.

According to the software update management method of configuration 8, it is possible to recommend update of the software of the vehicle control units to be performed under an appropriate situation by the use of the update recommendation information that defines the conditions regarding update of the software in association with the vehicle control units. This makes it possible to avoid the software from being updated under a situation that may cause trouble due to the fact that the vehicle control units cannot be used temporarily. As a result, it is possible to prevent inconveniences caused due to update of the software, and to improve the safety still further.

### REFERENCE SIGNS LIST

1 . . . Vehicle, 2 . . . Server, 3 . . . Software update system, 10 . . . Management ECU (software update management device), 11 . . . Device, 11A . . . Onboard detection device, 11B . . . Alarm device, 11C . . . Door lock device, 13 . . . Vehicle control unit, 13A . . . First ECU (first vehicle control unit), 13B . . . Second ECU (second vehicle control unit), 13C . . . Third ECU (third vehicle control unit), 21 . . . TCU, 22 . . . Display, 23 . . . Touch sensor, 24 . . . GNSS, 25 . . . In-cabin sensor, 26 . . . Alarm output unit 27 . . . Off-board sensor, 28 . . . Camera, 29 . . . Alarm output unit, 30 . . . Camera, 31 . . . Sensor, 32 . . . Lock drive unit, 110 . . . Processor, 111 . . . Program management unit, 112 . . . Recommendation processing unit, 120 . . . Memory (storage unit), 121 . . . Control program, 122 . . . Device information, 123 . . . Update recommendation information, 123A . . . Update recommendation information (first update recommendation information), 123B . . . Update recommendation information (second update recommendation information), 123C . . . Update recommendation information (second update recommendation information), 123D . . . Update recommendation information (third update recommendation information), 130 . . . Processor, 131 . . . Onboard detection device, 135 . . . Memory, 136 . . . Control program, 150 . . . Processor, 151 . . . Alarm control unit, 155 . . . Memory, 156 . . . Control program, 157 . . . Setting data, 170 . . . Processor, 171 . . . Door lock control unit, 175 . . . Memory, 176 . . . Control program, 177 . . . Setting data.

1. A software update management device comprising:
a storage unit configured to store update recommendation information including conditions for recommending update of software of vehicle control units mounted on a vehicle, the update recommendation information being associated with the vehicle control units; and
a recommendation processing unit configured to recommend update of the software based on the conditions in the update recommendation information, wherein
the conditions in the update recommendation information include a vehicle condition regarding a state of the vehicle and a situation condition indicating a situation suited for updating the software.

2. The software update management device according to claim 1, wherein
the vehicle condition includes the vehicle entering an ignition-off state, and
the situation condition includes the situation of the vehicle being suited for updating the software.

3. The software update management device according to claim 1, wherein
the vehicle control units include a first vehicle control unit configured to control a functional unit that is configured to operate until a first prescribed period of time elapses after the vehicle enters an ignition-off state,
the update recommendation information stored in the storage unit includes first update recommendation information that is associated with the first vehicle control unit, and
the first update recommendation information includes, as the situation condition, the first prescribed period of time elapsing after the vehicle enters the ignition-off state.

4. The software update management device according to claim 3, wherein the functional unit is an onboard detection device configured to detect presence of a person inside the vehicle.

5. The software update management device according to claim 4, wherein
the first update recommendation information includes, as the situation information, an additional condition applied when the onboard detection device detects a person, and
the additional condition includes a second prescribed period of time longer than the first prescribed period of time elapsing after the vehicle enters the ignition-off state.

6. The software update management device according to claim 1, wherein
the vehicle control units include a second vehicle control unit configured to control an alarm device that is configured to execute an alarm function while the vehicle is being stopped,
the update recommendation information stored in the storage unit includes second update recommendation information that is associated with the second vehicle control unit, and
the second update recommendation information includes, as the situation condition, at least one selected from a condition that a location of the vehicle is not in a high-risk area for theft and a condition that time at which the vehicle enters an ignition-off state is not included in a high-risk time window for theft.

7. The software update management device according to claim 1, wherein
the vehicle control units include a third vehicle control unit configured to control a lock device that is configured to lock and unlock the vehicle,
the update recommendation information stored in the storage unit includes third update recommendation information that is associated with the third vehicle control unit, and
the third update recommendation information includes, as the situation condition, being in a situation assumed to be suited for updating the software from a use record of the vehicle.

8. A software update management method executed by a computer that manages update of software of a vehicle, the software update management method comprising:
storing update recommendation information including conditions for recommending update of software of vehicle control units mounted on the vehicle, the update recommendation information being associated with the vehicle control units,
wherein the conditions in the update recommendation information includes a vehicle condition regarding a state of the vehicle and a situation condition indicating a situation suited for updating the software; and
recommending update of the software based on the conditions in the update recommendation information.
